(19) United States
(12) Patent Application Publication
(10) Pub. No.: US 2007/0079241 A1
(43) Pub. Date: Apr. 5, 2007

(54) APPARATUS AND METHOD FOR AUTOMATICALLY SELECTING AN AUDIO PLAY MODE

(76) Inventors: Han-Che Wang, Shenzhen (CN); Xiao-Guang Li, Shenzhen (CN); Kuan-Hong Hsieh, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/308,889

(22) Filed: May 23, 2006

(30) Foreign Application Priority Data
Sep. 30, 2005 (CN) 200510100076.2

(51) Int. Cl. G06F 3/00

(52) U.S. Cl. 715/727

(57) ABSTRACT

An apparatus and method for automatically selecting an audio play mode mainly is provided. The apparatus includes an audio reading unit and a play mode selecting unit. The audio reading unit reads an audio data frame, obtains and recognizes a play mode identifier from a frame header of the audio data frame, and generates an associated play mode control signal according to the recognized play mode identifier. The play mode selecting unit selects a corresponding play mode to output the audio data frame according to the play mode control signal from the audio reading unit. A related method is also provided.

### TECHNICAL FIELD

The present invention relates to audio devices and method therefor, and particularly to an apparatus and method for automatically selecting an audio play mode, used in an electronic device such as an electronic book reading device.

### GENERAL BACKGROUND

Reading have traditionally been regarded as the best way for obtaining information. Reading contents are conventionally supplied on printed books. Nevertheless, printed books include quires of paper and often reams paper, making the weight of the book can substantially heavy. Furthermore, printed books are often somewhat large in size and require a definite amount of space for storing them.

Therefore, electronic books have become a good alternative for handling reading contents. Different than printed books that comes in paper form, electronic books are read on an electronic book reading device that displays the reading content on a screen. A typically electronic book reading device includes a storage medium with recorded thereon reading content, a display for reading the reading content from the storage medium and for displaying the reading content on a screen, and a display control for controlling the display. In other words, the electronic book reading devices are used as printed books.

As electronic books has increased in popularity and are finding widespread acceptance in the general public. Electronic book reading devices has also been marketed with their functionalities. A big selection of electronic book reading apparatuses offers a variety of sound effects. These apparatus are able to identify certain data contents in a respective electronic book and output audio signals (e.g., music and speech) corresponding to the data contents. However, these apparatus only provide a single play mode when outputting the audio signals regardless of music or speech. As a result, these apparatuses only have a single sound effect and may not obtain a good fidelity of audio signals.

What is needed, therefore, is an apparatus and method for automatically selecting an audio play mode, which can identify the music and speech and select an appropriate play mode to output the music/speech, thereby obtaining different sound effect and maintaining the fidelity of the music/speech.

### SUMMARY

An apparatus for automatically selecting an audio play mode is provided. The apparatus mainly includes an audio reading unit and a play mode selecting unit. The audio reading unit is for reading an audio data frame, obtaining and recognizing a play mode identifier form a frame header of the audio data frame, and generating an associated play mode control signal according to the recognized play mode identifier. The play mode selecting unit is for selecting a corresponding play mode to output the audio data frame according to the play mode control signal from the audio reading unit.

A method for automatically selecting an audio play mode is also provided. The method includes the steps of: (a) reading an audio data frame, the audio data frame having a frame header thereof, and the frame header having a play mode identifier; (b) obtaining and recognizing the play mode identifier from the frame header of the audio data frame; (c) generating an associated play mode control signal according to the recognized play mode identifier; and (d) selecting a corresponding play mode to output the audio data frame.

Other advantages and novel features will be drawn from the following detailed description with reference to the attached drawing, in which:

### BRIEF DESCRIPTION OF DRAWINGS

FIG. 1 is a schematic diagram of a hardware infrastructure of an apparatus for automatically selecting an audio play mode in accordance with a preferred embodiment of the present invention; and

FIG. 2 is a flowchart of a preferred method for automatically selecting an audio play mode by utilizing the apparatus of FIG. 1.

### DETAILED DESCRIPTION

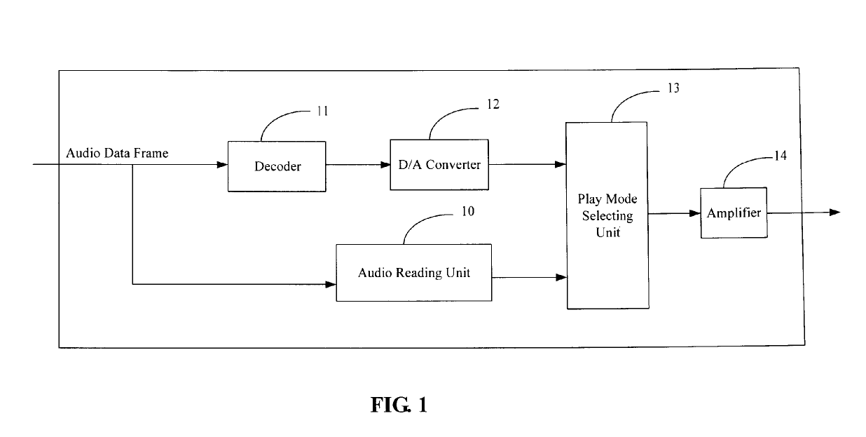

FIG. 1 is a schematic diagram of a hardware infrastructure of an apparatus for automatically selecting an audio play mode (hereinafter, “the apparatus”) in accordance with a preferred embodiment of the present invention. The apparatus 1 can be incorporated into an electronic device such as, for example, electronic book reading device, personal digital assistant, etc, for selecting an appropriate play mode to play audio data stored in the electronic device. The audio data may include music audio data or speech audio data. Furthermore, the audio data is composed of a plurality of audio data frames. Each of the audio data frames has a frame header. The frame header further includes an audio play mode identifier for identifying the audio data. The audio play mode identifier is preferably a single binary bit. When a bit value of the audio play mode identifier is a first predetermined value such as, for example ‘1’, the audio data is recognized as the music audio data and is designated a stereo play mode; alternatively, when the bit value of the audio play mode identifier is a second predetermined value such as, for example, ‘0’ the audio data is recognized as the speech audio data and is designated a mono play mode.

The apparatus mainly includes an audio reading unit 10, a decoder 11, a D/A converter 12, a play mode selecting unit 13, and an amplifier 14. The audio reading unit 10 is for reading the frame header, obtaining the audio play mode identifier from the read frame header, and generating an associated play mode control signal according to the bit value of the audio play mode identifier. For example, when the bit value of the audio play mode identifier is the first predetermined value, i.e., ‘1’, the audio reading unit 10 generates a stereo play mode control signal; alternatively, when the bit value of the audio play mode identifier is the second predetermined value, i.e., ‘0’, the audio reading unit 10 generates a mono play mode control. The decoder 11 is for decoding the audio data frame into a pulse code modulation (PCM) data stream. The D/A converter 12 is for converting the PCM data stream from a digital signal to an analog signal. The play mode selecting unit 13 is for selecting a corresponding play mode to output the analog PCM data stream through the amplifier 14, according to the play mode control signal from the audio reading unit 10. That is, the play mode selecting unit 13 outputs the analog PCM data streams (namely the music audio data) in a stereo play mode according to the stereo play mode control signal, and outputs the analog PCM data streams (namely the speech audio data) in a mono play mode according to the mono play mode control signal.

Therefore, by utilizing the apparatus, the electronic device (e.g., electronic book reading device) can automatically play background music in the stereo play mode and play speech in the mono play mode, thereby maintaining the fidelity of the audio data, and allowing readers to learn more effectively while reading.

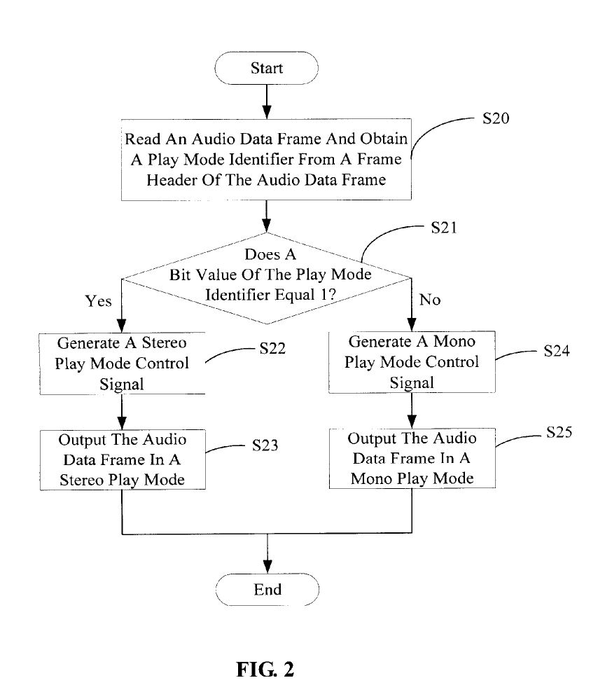

FIG. 2 is a flowchart of a preferred method for automatically selecting an audio play mode by utilizing the apparatus of FIG. 1. In step S20, the audio reading unit 10 reads the audio data frame and obtains the play mode identifier from the frame header of the audio data frame. In step S21, the audio reading unit 10 determines whether the bit value of the play mode identifier equals the first predetermined value, i.e., ‘1’. If the bit value of the play mode identifier equals ‘1’, in step S22, the audio reading unit 10 generates the stereo play mode control signal. In step S23, the play mode selecting unit 13 outputs the audio data frame (namely the music audio data) in the stereo play mode, according to the stereo play mode control signal from the audio reading unit 10. If the bit value of the play mode identifier equals ‘0’, not ‘1’, in step S24, the reading unit 10 generates the mono play mode control signal. In step S25, the play mode selecting unit 13 outputs the audio data frame (namely the speech audio data) in the mono play mode, according to the mono play mode control signal from the audio reading unit 10.

Although the present invention has been specifically described on the basis of a preferred embodiment and preferred method thereof, the invention is not to be construed as being limited thereto. Various changes or modifications may be made to the embodiment and method without departing from the scope and spirit of the invention.

What is claimed is:

1. An apparatus for automatically selecting an audio play mode, the apparatus comprising:
an audio reading unit for reading an audio data frame, obtaining and recognizing a play mode identifier from a frame header of the audio data frame, and generating an associated play mode control signal according to the recognized play mode identifier; and
a play mode selecting unit for selecting a corresponding play mode to output the audio data frame, according to the play mode control signal from the audio reading unit.

2. The apparatus according to claim 1, wherein the audio data frame is selected from the group consisting of a music data frame and a speech data frame.

3. The apparatus according to claim 2, wherein the play mode is selected from the group consisting of a stereo play mode and a mono play mode.

4. The apparatus according to claim 3, wherein the play mode identifier is indicated by a single binary bit.

5. The apparatus according to claim 4, wherein the audio reading unit recognizes the audio data frame as the music data frame and generates a stereo play mode control signal, if a bit value of the play mode identifier is a first predetermined value.

6. The apparatus according to claim 5, wherein the play mode selecting units outputs the music data frame in the stereo play mode.

7. The apparatus according to claim 4, wherein the audio reading unit recognizes the audio data stream as the speech data frame and generates a mono play mode control signal, if a bit value of the play mode identifier is a second predetermined value.

8. The apparatus according to claim 7, wherein the play mode selecting units outputs the speech data frame in the mono play mode.

9. A method for automatically selecting an audio play mode, the method comprising the steps of:
reading an audio data frame, the audio data frame having a frame header thereof, and the frame header having a play mode identifier;
obtaining and recognizing the play mode identifier from the frame header of the audio data frame;
generating an associated play mode control signal according to the recognized play mode identifier; and
selecting a corresponding play mode to output the audio data frame.

10. The method according to claim 9, wherein the audio data frame is selected from the group consisting of a music data frame and a speech data frame.

11. The method according to claim 10, wherein the play mode is selected from the group consisting of a stereo play mode and a mono play mode.

12. The method according to claim 11, wherein the play mode identifier is indicated by a single binary bit.

13. The method according to claim 12, wherein the step of obtaining and recognizing the play mode identifier further comprises the steps of:
recognizing the audio data frame as the music data frame if a bit value of the play mode identifier is a first predetermined value; and
recognizing the audio data frame as the speech data frame if a bit value of the play mode identifier is a second predetermined value.

14. The method according to claim 13, wherein the step of selecting a corresponding play mode to output the audio data frame further comprises the steps of:
outputting the music data frame in the stereo play mode; and
outputting the speech data frame in the mono play mode.

15. An apparatus for automatically selecting an audio play mode, the apparatus comprising:
an audio reading unit for obtaining a play mode identifier by reading an audio data frame; and
a play mode selecting unit for receiving the obtained play mode identifier from the audio reading unit and selecting a corresponding play mode to output the audio data frame, according to the obtained play mode identifier.

16. The apparatus according to claim 15, wherein the audio data frame is selected from the group consisting of a music data frame and a speech data frame.

17. The apparatus according to claim 16, wherein the play mode is selected from the group consisting of a stereo play mode and a mono play mode.

18. The apparatus according to claim 17, wherein the play mode selecting unit outputs the music data frame in the stereo play mode.

19. The apparatus according to claim 18, wherein the play mode selecting unit outputs the speech data frame in the mono play mode.
